(19) United States
(12) Patent Application Publication
(10) Pub. No.: US 2007/0180039 A1
(43) Pub. Date: Aug. 2, 2007

(54) ANONYMOUS DISPOSABLE EMAIL ADDRESSING SYSTEM AND METHOD OF USE THEREO

(76) Inventors: David Sutidze, San Rafael, CA (US); Joel Fink, San Rafael, CA (US); Nodar Skhvitaridze, San Francisco, CA (US); Vladimir Volosnikov, San Francisco, CA (US)

Correspondence Address: TURNING POINT LAW, 100 SMITH RANCH ROAD, SUITE 116, SAN RAFAEL, CA, 94903, US

(21) Appl. No.: 11/670,407

(22) Filed: Feb. 1, 2007

Related U.S. Application Data
(60) Provisional application No. 60/764,239, filed on Feb. 1, 2006.

(51) Int. Cl. G06F 15/16

(52) U.S. Cl. 709/206

(57) ABSTRACT

A method and system directed toward establishing a communication channel for communication between an email user and third party email users, employing anonymous disposable email addresses of the email user associated with one or more third party email users to minimize email spam. The email user may further block email communication with a third party email user by electing to delete the communication channel associated with the third party email user. Moreover, the third party email user receiving an email through a communication channel may also elect to delete the communication channel to block receiving any further email communication from an email user.

### CROSS-REFERENCE TO RELATED APPLICATIONS

This application claims the benefit under 35 U.S.C. Section 119(e) of U.S. Provisional Application No. 60/764,239 filed Feb. 1, 2006. The contents of this application are hereby incorporated by reference into the present disclosure.

### THE FIELD OF THE INVENTION

The present invention relates to electronic message systems. More particularly, the present invention relates to methods, systems, and computer program products for reducing unsolicited messages in an electronic message system.

### BACKGROUND AND RELATED ART

Unsolicited electronic messages, also known as spam, are a significant problem for users of electronic message systems, such as electronic mail systems. Whether in a personal or a business context, spam consumes both computing and human resources. For some systems, spam may account for anywhere from one-third to one-half of all email traffic, and in extreme cases, spam may be responsible for 80% of email traffic or more. Although the cost in computing resources is significant, the amount of time users waste in reviewing and deleting spam can represent an unacceptable drain on productivity or leisure time.

The problems caused by spam have lead to reluctance on the part of users to disclose their email addresses in many circumstances, such as on a web site or in publications. Once an address is disclosed, it can be discovered by web crawlers initiated by spammers (i.e., those who send spam) and distributed to email marketers. Much like telemarketing, spam is viewed by many as intrusive and undesirable. Users are then forced to sift through massive amounts of irrelevant spam and/or deploy expensive tools and resources to eliminate as much spam as possible.

Email aliasing is a widely understood that email users employ to protect their primary or actual email address. An email alias is a public identity (other than the primary address) for a user. The alias can take any form, but often has some relationship to the user's primary address. For example, “firstinitial.lastname@company.com” may be used as an alias for a user's primary address “firstname.lastname@company.com” which the user ordinary does not disclose or only discloses to trusted parties. Users with no control over their email server may achieve the same result by creating multiple email accounts on public domain web servers (Hotmail, Yahoo, Google, etc.) to keep their primary email address from being discovered by spammers. Some users may have separate email accounts for friends, family, business, and for submitting to web sites. If an alias or address becomes overloaded with spam, the user simply chooses another alias or address, but usually retains the same primary address.

These simple addressing schemes solve a few problems for a short period of time, but they create larger problems of manageability and usability. Eventually they are no better in reducing spam than using just one address, and they introduce new problems. If an address or alias is given to multiple parties, and some of the parties are untrusted, the entire address or alias is prone to spam. These addresses or aliases are hard to delete because subscriptions to web sites and the user's contacts must be updated. It is the recipient of the user's email, or a party other than the user, that is responsible for insuring the integrity of a user's email address and therefore minimizing the amount of unsolicited email received.

Often spammers make use of email services offering alias generation to circumvent blocking of emails by a recipient. Junk mail filters commonly available permit a user to mark an email address as “junk” or spam, and will automatically redirect any future emails from that email address to a folder specifically designated to receive junk email. If a spammer makes use of an alias generation service, the spammer can simply generate a new alias address which will not be viewed as junk by the same user's filter.

Once methods to reduce spam includes encoding the email message with Public Key encryption, or presenting an email sender a challenge question before permitting an email to be sent to a user. These schemes require some prior contact between the sender and the user, or the recipient to pre-determine which senders the user will accepted email from.

### SUMMARY OF THE INVENTION

It should be appreciated that this summary is intended only to provide a brief overview of the invention and should not be interpreted as limiting its scope, which is defined by the claims. The present invention reduces unsolicited electronic messages by creating one or more controllable communication channels which is associated with an anonymous disposable email addresses for an email user while avoiding the need to disclose or have a permanent email address, such as a traditional email address that identifies the email account of a particular user at a particular domain. Since there is no need for a base email address, spammers (i.e., senders of unsolicited electronic messages) can only harvest (typically) short-lived and email user controllable disposable addresses. For ease of use and easier memorization, email users are still given a base identity, called herein a base email address, but the identity is used to request disposable addresses and in many circumstances cannot be harvested for sending spam. Users are further provided with one or more organized lists of communication channels and the anonymous disposable email addresses associated with the user's base email address, with which the user can control the usage of the communication channel and the anonymous disposable address in use at any particular time.

In accordance with the first aspect of the present invention, the email user drafts an email message to be sent to an intended recipient of the email. The email user automatically creates a communication channel upon the single action of sending the email message. The communication channel is comprised of the user's base email address, email addresses of the one or more intended recipients, and an anonymous disposable email address automatically created by the sending function, and one or more options selectable by the use. The communication channel may include one or more options selectable by the intended recipient to further affect the usage of the communication channel. Prior to sending the email message to the intended recipient, the email user is presented with a selectable option to send the email with the anonymous disposable email address being inserted into the return email address of the email message header. Conversely, by not selecting the option, the email message will be sent to the intended recipient with the email user's base email address remaining in the header of the email message. In either case, the act of clicking the SEND button to send the email, creates the communication channel and determines an anonymous disposable email address associated with the communication channel. If the email user requests the email to be sent to the recipient using a disposable email address, the email message, along with header information, are sent to an address generation server of the present invention. The channel management server receives an electronic message that requests a randomly generated disposable address to be used as the return address to send with the email message to an intended recipient. If a recipient of the email message, whether it be the intended recipient or otherwise, replies to the user's email, the reply email is addressed to the disposable email address and not the user's base email address. Likewise, if a sender of unsolicited email harvests the disposable email address, the user's base email address is not discovered.

In another aspect of the present invention, if the user is drafting an email message addressed to more than one intended recipient, separate communication channels are established for each intended recipient, where each communication channel comprises a unique anonymous disposable email address associated with an intended recipient email address. By creating a communication channel for each intended recipient, the user may control the flow of email to and from each intended recipient individually.

In another aspect of the present invention, upon receipt of an email message directed to a disposable address, the channel management server verifies that the disposable address is still in use, and forwards the email message to the email user. If use of the disposable address has been discontinued, the address generation server rejects the email and returns a notification to the sender that the disposable email address is no longer in use.

Senders of unsolicited electronic messages generally rely on anonymity and are unwilling to supply a valid return address. Often times, a sender of unsolicited emails will make use of email services that generate alias email addresses to use as the mailing address for the sender. Moreover, in most cases the sender of unsolicited emails will not even include a valid email address in the header information, thereby making it impossible to track the sender of the unsolicited email message and put a halt to such unwanted email. In yet another aspect of the present invention, the recipient of an email message from an email user processed through a communication channel of the present invention will receive in the body of the email a hypertext link that if clicked will delete the communication channel. Any future emails sent by the email user to the recipient of a deleted communication channel will be blocked and not sent to the intended recipient, without regard to whether the sender of the unsolicited email message revealed a valid return email address or spoofed a return email address. An error message will be generated and delivered to the sender notifying the sender of the blocked channel. The intended recipient has the ability to control if an email message may be sent from a user through a communication channel. This aspect serves to minimize repeated unauthorized emails from a user utilizing the invention to create anonymous email addresses therefore shielding the user's identity.

In another aspect of the invention, the email user is presented with an organized list of each communication channel associated with the email user's base email address, the intended recipient or recipients thereof, and options selectable by the sender in order for the user to manage the flow of email traffic utilizing the communication channel. A means whereby the user indicates a particular communication channel should be discontinued is provided. If a communication channel is compromised and the user is receiving email addressed to the anonymous disposable email address from a sender other than the sender associated with the communication channel, the user may choose to delete the communication channel. The communication channel is moved to a list of deleted communication channels on the server database, and future emails sent to the email user from any recipient addressed to the anonymous disposable address are directed through the deleted communication channel, and the email message is not routed to the email user. The user can further elect to move the communication channel from the list of deleted communications back to the list of active communication channels, thereby electing to send and receive emails through such communication channel.

Unsolicited electronic messages are reduced because the sender only becomes aware of the email user's disposable email address. The email user can choose to send a single email and automatically generate a disposable email address by a single click action and thereafter delete the disposable email address without disclosing the email user's base email address. The email user could also engage in a series of emails with a particular recipient utilizing one disposable email address for all such communications. At any point, the email user may terminate any further communications with the intended recipient by deleting the disposable email address known to the intended recipient. In the event the email user receives unsolicited email from the intended recipient or from any other email sender to a particular disposable email address associated with the user, the email user would be able to delete the disposable email address used by the sender of the unsolicited email, and thereby places the communication channel of that disposable email address on the deleted communication channel list.

In a further aspect of the present invention, requests for a disposable address may also be made using a web based protocol. A user intending to fill out an online or hard copy form where the user must provide an email address for communication, may be reluctant to provide the user's base email address. A user makes a request for a disposable email address from the address generation server of the present invention, and a disposable email address is provided. The user is presented with a list of all disposable email address requested, wherein the user may delete any such disposable email address in use.

Senders of unsolicited electronic messages generally are unwilling to expend significant resources to send unsolicited email messages. Accordingly, the present invention requires email senders to expend resources to acquire an email user's disposable email address, which may be, or may soon be, deleted. However, intended recipients of an email user's disposable email address who limit or send no unsolicited email message to the email user will enjoy an email communication channel that is no different from that using the email user's base email address.

Another aspect of the present invention is the sending and receiving of advertisement messages embedded with the email messages sent from the user or received by the user. A user subscribing to the email service submits a profile upon creation of the user's account. A component of the profile may include a consenting user electing to send and receive email messages with one or more advertisement messages embedded in the message, which consent may be in consideration for utilizing the email service without a fee. A non-consenting user subscribing to the email service, upon consideration of a fee, elects to send and receive email messages without any advertisement message embedded. The election of the user to be either a consenting user or a non-consenting user is stored in the user's profile.

If a consenting user sends an email message, the channel management server of the present invention uses the sender and intended recipient data to determine whether an advertisement message is inserted in the email message. The channel management server determines if the sender is a non-consenting user or a consenting user. If the sender is a non-consenting user, the email message is routed to the intended recipients without the insertion of an advertisement message. If the sender is a consenting user, the channel management server must make additional determinations before routing the email message to the intended recipient.

The channel management server next determines if an intended recipient is a subscriber to the email service of the sender. If an intended recipient is a subscriber to the email service of the sender, the profile of the intended recipient is retrieved from the database storage where it is further determined if the intended recipient is a consenting user or a non-consenting user. If the intended recipient is a consenting user, one or more advertisement messages are inserted by the channel management server into the body of the email message prior to routing the email message to the intended recipient. If the intended recipient is a non-consenting user, the email message is routed to the intended recipient without the insertion of an advertisement message.

If it is determined an intended recipient is not a subscriber to the email service of the sender, an advertisement message is inserted into the body of the email message prior to routing the email message to the intended recipient.

It is a feature of the present invention that an email sent to more than one intended recipients is processes such that the email message could be received by one intended recipient with an advertisement message inserted, while another intended recipient may receive the same email message without an advertisement message inserted.

It is a further feature of the present invention that a consenting user may configure a profile to identify subject matter of advertisements of which the consenting user may wish to receiver. The consenting user may select from a list of predefined subject matters such as sports, finance, personal improvement, news, horoscopes, personal classifieds, and the like. If a consenting user has selected one or more subject matters and has stored the selections in the consenting user's profile, if an email message addressed to the consenting user is processed to include an advertisement message, the advertisement message will pertain to the one or more subject matters contained in the consenting user's profile. If a consenting user has not selected any subject matters to store in the consenting user's profile, the email message is processed such that an advertisement message is inserted into the email address according to keywords contained in the email message subject line and body. If the email message is sent to an intended recipient that is not a subscriber to the sender's email service, the email message is processed such that an advertisement message is inserted into the email address according to keywords contained in the email message subject line and body.

Additional features and advantages of the invention will be set forth in the description which follows, and in part will be obvious from the description, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 shows steps and acts for generating and sending an email message using a disposable email address and an intended recipient's response in accordance with an embodiment of the present invention;

FIG. 2 shows steps and acts for receiving an email addressed, in accordance with an embodiment of the present invention; and

FIG. 3 shows steps and acts for creating, processing and sending an email message and the insertion of an advertisement message.

FIG. 4 shows steps and acts for receiving and processing an email message and the insertion of an advertisement message.

FIG. 5 is a block diagram of the present invention.

### DETAILED DESCRIPTION OF THE PREFERRED EMBODIMENT

In the following detailed description, reference is made to the accompanied drawings in which are shown exemplary embodiments of the invention. These embodiments are described in sufficient detail to enable those skilled in the art to practice the invention, and it is understood that other embodiments may be utilized, and other changes may be made, without departing from the spirit or scope of the invention.

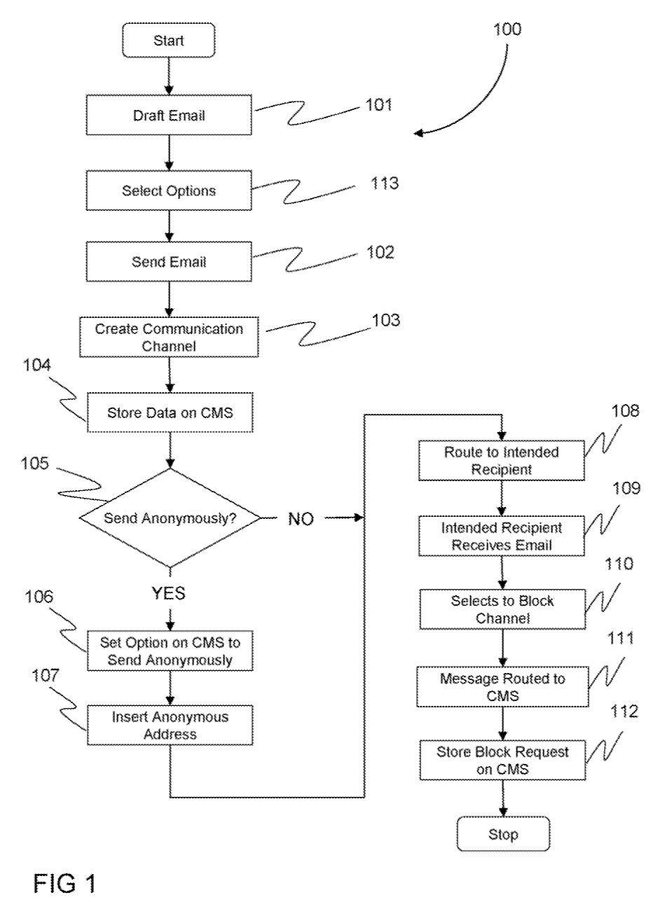

Turning now to FIG. 1, which illustrates an overview 100 of the process flow for a user to draft and send an email message utilizing a communication channel and an anonymous disposable email address. After a user logs into an account on the web server, the user composes a message using a commonly used web based email application 101 to be sent to an intended recipient at an email address supplied by the user. The user is presented with the option 113 of sending the email to the intended recipient using the user's base email address stored in the information associated with the user's account or to send the email using the anonymous disposable email address as the user's email address. The user then performs the single action 102 of sending the email message to the intended recipient. Upon the act of sending the email message, and prior to the email message being routed to the intended recipient, establishes a communication channel 103. The Channel Management Server determines an anonymous disposable email address, associates the anonymous disposable email address with the intended recipient's email address, and stores the user's option to either send the email message anonymously or disclose the user's base email address, on the CMS 104. Processing flows to a decision box 105 where the CMS determines if the user has elected to send the email to the intended recipient anonymously. If the user elects to send the email message using the user's base email address, the base email address is disclosed to the recipient and the email address is routed to the intended recipient 108. The user may otherwise elect to send the email message anonymously. If the user elects to send the email message utilizing a disposable email address generated by the CMS, a request is sent to the address generation server of the present invention to store the user's election 106 and to further process the email message. At block 107 the user's base email address, in the header and body of the email message, is removed and replaced with the anonymous disposable email address stored by the CMS and associated with the communication channel associated with the intended recipient's email address. The email message is then routed to the intended recipient 108 only utilizing with the disposable email address, thereby maintaining the confidentiality of the user's base email address.

The intended recipient receives the email message 109 from the user in the manner of the intended recipient's choice. The body of the email message contains a hypertext link inserted at the bottom of the message by the CMS, which if clicked by the recipient 110, would send an instruction message to the CMS to block any further emails to the intended recipient from the user 111. The CMS processes the instruction and places the communication channel on the deleted communication channel list of the CMS 112. Emails from the user are checked against the deleted communication channel list to determine if the intended recipient has previously blocked receipt of emails from the user.

One skilled in the art would appreciate that in a further embodiment of the present invention, the user also has the option to utilize a third party client based email application, such as Outlook or Eudora, where the user identifies the outgoing email server as the mail server of the present invention. The user identifies his account name and password, and when sending an email, the third party email application logs into the mail sever of the present invention for purposes of sending the user's email. When the user elects to send the email from the third party email application through the mail server of the present invention, the mail server sends a request to the address generation server to generate a disposable email address. The disposable email address is entered into the database of the present invention, and further provided to the user for management as describe hereinbelow.

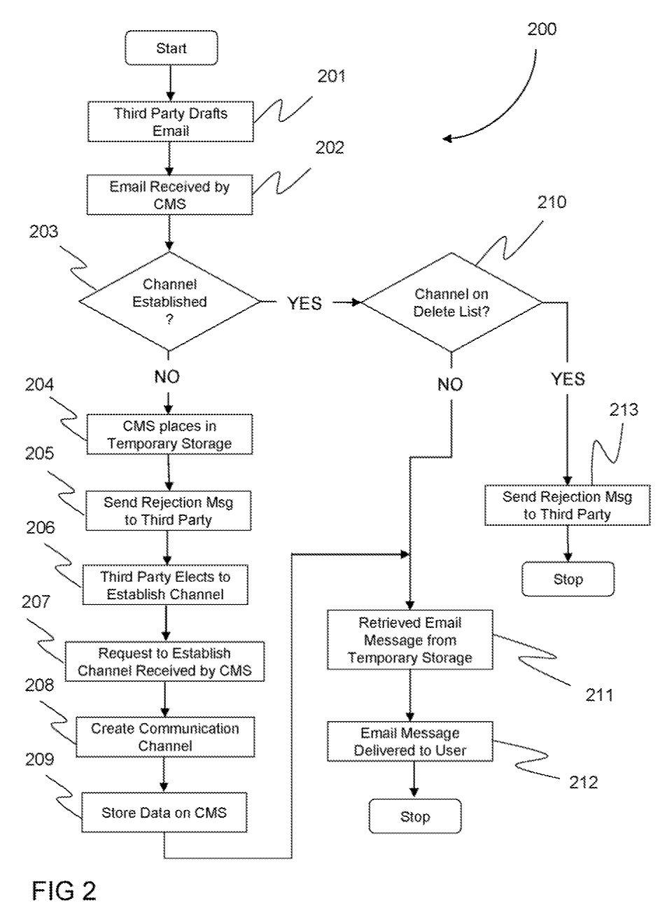

FIG. 2 illustrates an overview 200 of the process flow of a third party sending an email message to a user. The process begins by the third party drafting an email message 201 addressed to either the base email address of a user or the anonymous disposable email address previously provided to the third party. The email is received by the email server of the user 202 and is processed by the CMS according to the present invention. The process flows to a decision block 203 where the CMS determines if a communication channel has been established. The CMS compares the third party sender's email address to the list of addresses in the list of communication channels for the user recipient. If a communication channel has not been established, the process flows to block 204 where the CMS places the email message in a temporary storage location on the server. The CMS next sends a rejection message to the third party 205 indicating the message cannot be delivered to the user. A hypertext link clickable by the third party is included in the message, whereupon clicking the hypertext link the third party elects to establish a communication channel with the user 206. The CMS receives the request to establish the communication channel 207 whereupon the CMS generates an anonymous disposable email address 208, associates the anonymous disposable email address with the user and the third party, and stores the communication channel data on the server 209. Once the communication channel has been established, the CMS in block 211 retrieves the email message from the third party from the temporary storage location on the server and routes the email to the user 212.

If, in decision block 203, the CMS determines a communication channel has been established, the process flow to decision block 210 where the CMS determines if the communication channel is on the deleted communication channel list. If the communication channel is on the deleted communication channel list, a rejection message 213 (without a hypertext link to establish a communication channel) is sent to the third party indicating the third party is unable to send email to the user. If in decision block 210 the CMS determines the communication channel is not on the deleted communication channel list, the email message is retrieved from the temporary storage location on the server 211 and routes the email to the user 212.

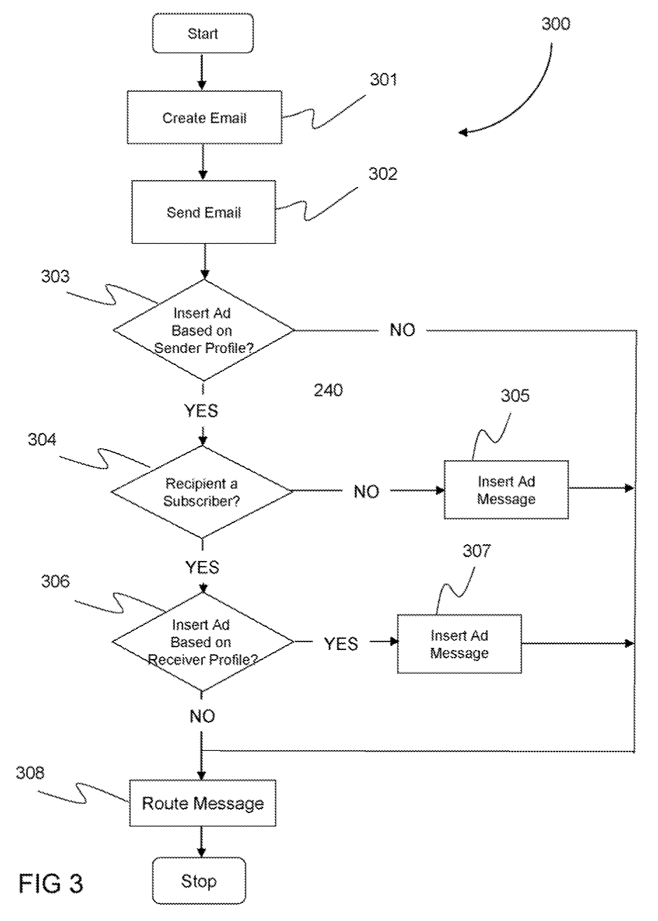

FIG. 3 illustrates an overview 300 of the process flow of a user creating and sending an email message to a user where an advertisement message may be inserted. The user first creates an email message 301 using either a web-based mail application or a third party client associated with the mail server of the present invention. The user next takes action 302 to send the email, which is first processed by the Advertisement Management Server (AMS) of the present invention. The AMS determines in block 303 from the user's subscription profile whether the sender has elected to include advertisement message in the user's email messages. If the user has elected to not include any advertisement message in the email message, the email message is routed to the mail server 308 and delivered to the intended recipient.

If, the user's profile indicates the user has elected to include adverting messages in the email message, the flow progresses to decision block 304 where the AMS determines if the intended recipient of the email message is also a subscriber. If the intended recipient is not a subscriber, the AMS inserts an advertisement message into the body of the email message 305. The email message, including the advertisement message, is routed to the mail server 308 and delivered to the intended recipient. If the intended recipient is a subscriber, the process flows to decision block 306 for further process by the AMS.

In decision block 306, the AMS determines from the intended recipient's profile, whether the intended recipient has elected to include advertisement message in the intended recipient's email messages. If the intended recipient's profile indicates the intended recipient has elected to include advertisement messages, the AMS inserts an advertisement message into the body of the email message 307. The email message, including the advertisement message, is routed to the mail server 308 and delivered to the intended recipient.

If, in decision block 306, the AMS determines from the intended recipient's profile the intended recipient has elected to not include any advertisement message in the email message, the email message, without any advertisement message, is routed to the mail server 308 and delivered to the intended recipient.

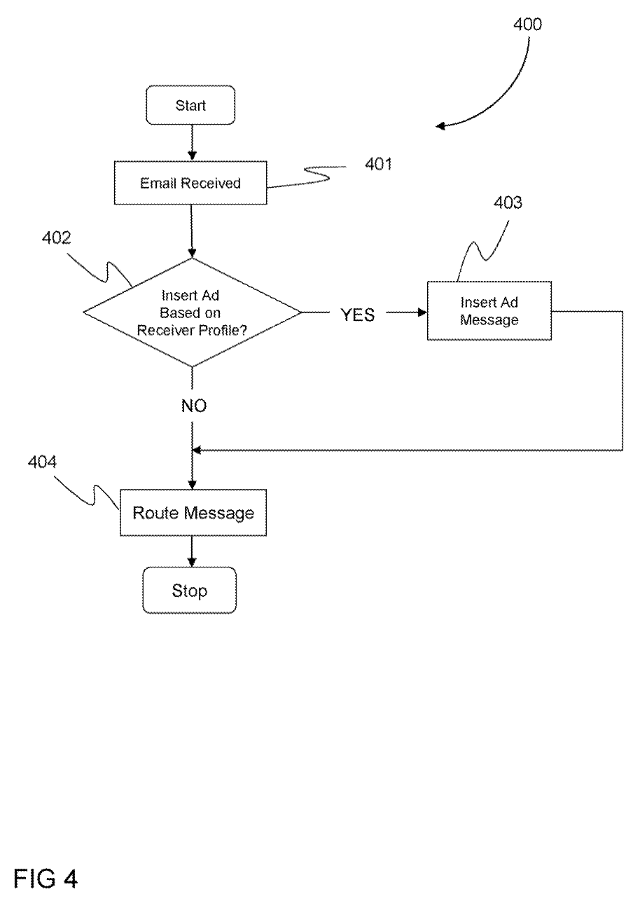

FIG. 4 illustrates an overview 400 of the process flow of a user receiving an email message where an advertisement message may be inserted. The email message is first received by the mail server in block 401 and processed by the AMS. In decision block 402 the AMS determines from the user's subscription profile whether the user has elected to receive advertisement messages in the user's email messages. If the user's profile indicates the user has elected not to receive any advertisement messages, the email message is routed to the user 404. If the user's profile indicates the user has elected to include advertisement messages, the AMS inserts an advertisement message into the body of the email message 403. The email message, including the advertisement message, is then routed to the user 404.

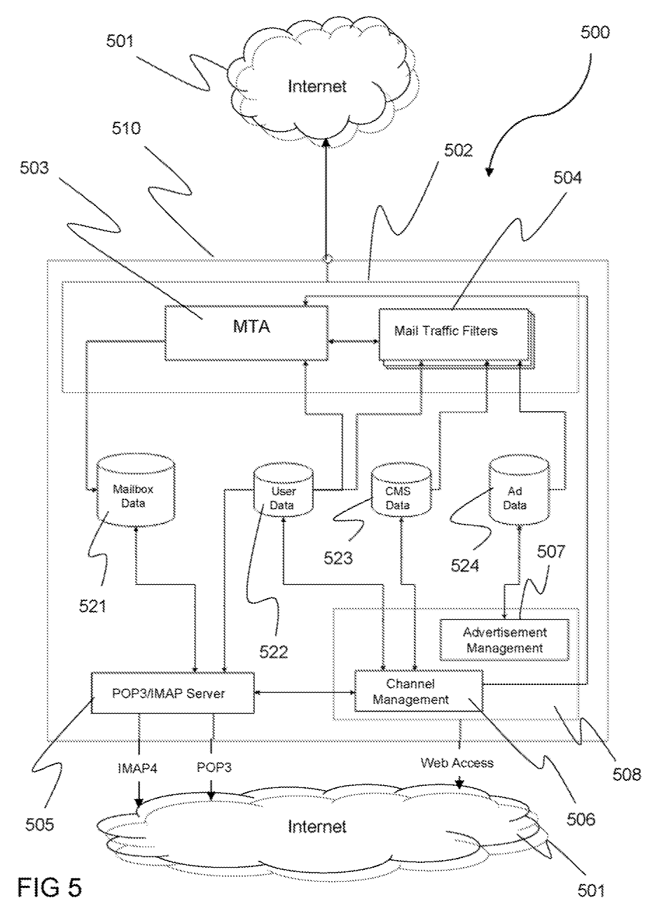

FIG. 5 illustrates one embodiment of a management server and mail server 500, according to one embodiment of the invention. The management server 508 comprises the Channel Management Server (CMS) 506 and the Advertising Management Server (AMS) 507, is configured to operate as a website, or the like, and is connected to a data network such as the Internet 501. A user is able to determine options and thereby configure the management server and the CMS 506 and AMS 507 contained therein. The CMS 506 manages the user's profile and further manages information related to communication channels associated with a user. The CMS 506 also processes email messages of a user according to the options selected by the user contained in the user's profile and the communication channels associated with the user. The user's profile data is stored in database 522. The communication channel data is stored in database 523. The AMS 507 manages the insertion of advertising information into the email message by instructing the Mail Traffic Filter 504 to insert the email message prior to delivering the email message through the Message Transfer Agent (MTA) 503 to an intended recipient across the Internet 501 or depositing the email message in the intended recipient's mailbox 521 on the server. Advertising data used by the AMS 507 is stored in database 523.

A mail server 508 employing a variety of email protocols, including, but not limited to, Post Office Protocol (POP), Internet Message Access Protocol (IMAP), and the like, may be utilized to manage and communicate email messages of the user. The user may also gain access to the management server 508 and store profile information in database 522. Messages of the user are stored in mailbox databox 521, which are communicated across the Internet 501 to and from third parties through a mail server 502 employing a variety of email protocols, including, but not limited to Simple Mail Transfer Protocols (SMTP) and the like. The email message sent through the mail server 502 is transported by the MTA 503 of the mail server according to the data contained in the user profile database 522 in the manner specified by the CMS 506. It is in the Mail Traffic Filter 503 of the present invention where email messages are processed and the email address information is replaced with the anonymous disposable email address and the advertisement message is inserted in the email message prior to either deliver to the intended recipient across the Internet 501 or placed in the user's email data storage 521 as the case may be.

One skilled in the art will readily appreciate that the changing of the Sent From address, or any other information identifying the sender, or the insertion of advertisement messages into the body of an email, can be done by a server such as the one described herein. Email client applications may further manipulate the server such that the server will create a communication channel, process the email message accordingly, and insert an anonymous disposable email address or an advertisement message into the email message, as the case may be.

It will be understood by one skilled in the art that each block of the flowchart illustrations, and combination of blocks in the flow chart illustration, may be implemented by computer program instructions. It will be further understood by one skilled in the art that the system of the present invention can be implemented in a number of ways including as software executed by standard computer hardware having network connectivity. Although preferred embodiments of the present invention have been described, those of skill in the art will appreciate that modifications and variations may be made without departing from the spirit and scope thereof.

We claim:

1. A method of facilitating anonymous email communication over a network comprising:
generating and displaying an email message to be sent by a sender to an intended recipient inserting the email address of said intended recipient;
creating at least one communication channel stored on a server associated with the sender in response to a single action of sending the email message to the intended recipient, said communication channel comprising:
determining an anonymous disposable email address comprising
an anonymous email address prefix; and
a domain name;
associating said anonymous disposable email address with the base email address of the sender;
the email address of a said intended recipient;
one or more options selected by the sender used to determine criteria for routing the message to the said intended recipient; and
one or more third party options selectable by the said intended recipient;
processing said email message according to the one or more options selected by the sender prior to routing the email message to the intended recipient; and
routing the message to the intended recipient.

2. The method of claim 1 wherein the email message is addressed and routed to a plurality of intended recipients and only one said communication channel comprises a plurality of email addresses each associated with said intended recipients.

3. The method of claim 1 wherein the sender selects an option to process the email message by replacing the sender's email address with said anonymous disposable email address in the header and body of the email message to be delivered to the intended recipient, such that only the anonymous disposable email address is revealed to the intended recipient and the base email address of the sender is not revealed.

4. The method of claim 1 wherein the anonymous disposable email address prefix is a randomly generated value.

5. The method of claim 1 wherein the randomly generated value is based in part upon the year, month, date, hour, minute and second the anonymous disposable email address is created.

6. The method of claim 4 wherein the email prefix further comprises:
one or more constant alpha-numeric characters; and
said randomly generated value.

7. The method of claim 1 wherein the email address suffix is a domain name selected by the sender.

8. The method of claim 1 wherein the method of determining said anonymous disposable email address further comprises:
a) comparing the anonymous disposable email address to other anonymous disposable email addresses stored on the server;
b) determining if said anonymous disposable email address is the same as any other anonymous disposable email address stored on the server, and
c) iteratively repeating steps a-b until a unique anonymous disposable email address has been determined.

9. The method of claim 1 wherein the email message received by the intended recipient includes in the body of the email message a hypertext link clickable by the intended recipient to select to disable the communication channel so that an email from the sender addressed to the intended is rejected by the sender's server, not routed to the intended recipient, and an error message is routed to the sender.

10. A method of facilitating anonymous email communication over a network comprising:
receiving an email message from a sender addressed to an intended recipient associated with a receiving email server;
determining if a communication channel has been established on the receiving email server between the sender of the email message and the intended recipient wherein the communication channel comprises:
at least one anonymous disposable email address where the anonymous disposable email address is associated with the email address of the intended recipient;
the email address of at least one sender; and
one or more options selected by the intended recipient to determine criteria for routing the message to the intended recipient;
one or more third party options selected by the intended recipient;
processing said email message according to the one or more options selected by the intended recipient prior to routing the email message to the intended recipient; and
routing the message to the intended recipient.

11. The method of claim 10 wherein if the communication channel has not been established, the email message is rejected, not routed to the intended recipient, and an error reply email message is routed to the sender.

12. The method of claim 10 wherein if the communication channel is determined to be established and the intended recipient has selected the option to receive an email message through the communication channel, processing the email message by routing the email message to the intended recipient.

13. The method of claim 10 wherein if the communication channel is determined to be established and the intended recipient has selected the option to not receive an email message through the communication channel, the email message is processed by rejecting the email message, not routing it to the intended recipient, and sending an error reply email message is routed to the sender.

14. The method of claim 10 wherein if the communication channel is determined not to be established, the email message is processed by temporarily storing said email message on the intended recipient's email server, routing a reply email message to the sender notifying the sender a communication channel has not been established with a hyperlink clickable by the sender to elect to establish a communication channel with the intended recipient.

15. The method of claim 14 whereupon the election by the sender to establish a communication channel, the steps further comprising:
communicating to the mail server of the intended recipient to unilaterally establish a communication channel with the intended recipient;
the channel management server establishes a communication channel; and
the email message is routed to the intended recipient.

16. The method of claim 14 whereupon the election by the sender to establish a communication channel, the steps further comprising:
communicating to the intended recipient's email server requesting the establishment of a communication channel;
send an email request to the intended recipient containing a clickable hyperlink;
upon the user clicking the hyperlink, the channel management server established a communication channel; and
the email message is routed to the intended recipient.

17. A method of facilitating anonymous email communication over a network comprising:
creating a communication channel stored on an email server associated with the managing party comprising:
at least one anonymous disposable email address where the anonymous disposable email address is associated with the email address of at least one managing party;
at least one website data associated with the anonymous disposable email address comprising:
website URL;
account name associated with the website URL; and
password associated with the account name; and
one or more options to determine criteria for routing the message to the managing party,
receiving a message to be delivered through the communication channel.

18. A method of sending an email message containing one or more advertisement messages comprising:
creating a sender-defined profile;
composing and sending an email message;
determining if there exists a recipient-defined profile;
processing the email message to include one or more advertising messages based upon the sender-defined profile and a recipient-defined profile, if any; and
routing the email message to the recipient.

19. The method of claim 18 wherein the email message is processed to not include the one or more advertising messages based upon the sender-defined profile containing a selection to send no advertisements.

20. The method of claim 18 wherein, if there exists a recipient-defined profile containing a selection to send no advertisements, the email messaged is process to not include the one or more advertising messages.

21. The method of claim 18 wherein, if it is determined there is a recipient-defined profile, the email messaged is process to include the one or more advertising messages based upon the sender-defined profile containing a selection to send advertisements and the recipient defined profile to receive advertisements.

22. The method of claim 18 wherein, if it is determined there is no recipient-defined profile, the email messaged is process to include the one or more advertising messages based upon the sender-defined profile containing a selection to send advertisements.

23. A method of receiving an email message containing one or more advertisement message comprising:
creating a recipient-defined profile;
receiving an email message;
determining if there is a sender-defined profile;
processing an email message based upon the recipient-defined profile and a sender-defined profile, if any; and
routing the email message to the recipient.

24. The method of claim 23 wherein, if it is determined there is a sender-defined profile, the email message is processed to not include the one or more advertising messages based upon the sender-defined profile containing a selection to send no advertisements.

25. The method of claim 23 wherein the email message is processed to not include the one or more advertising messages based upon the recipient-defined profile containing a selection to receive no advertisements.

26. The method of claim 23 wherein the email message is processed to include the one or more advertising messages based upon the recipient-defined profile containing a selection to receive advertisements and the sender-defined profile containing a selection to send advertisements.

27. The method of claim 23 wherein the email message is processed to include the one or more advertising messages based upon the recipient-defined profile containing a selection to receive advertisements and no sender-defined profile.

28. A system for managing a communication channel over a computer network, comprising:
an email server having an interface for communication over the computer network;
a message transfer agent associated with the email server for sending and receiving email messages to a communication device;
a channel management server for creating one or more communications channel and selecting options for managing a communication channel that are associated with a managing party;
a database management server for storing data associated with a communication channel.

29. The system of claim 28 wherein the database management server data comprises:
one or more anonymous disposable email addresses;
the email address of a non-managing party; and
one or more options selectable by the managing party for affecting the anonymity of the identity of the managing party.

30. The system of claim 28 wherein the anonymous disposable email address is associated with one or more email addresses of a non-managing party.

31. The system of claim 28 wherein the anonymous disposable email address is associated with one or more websites.

32. The system of claim 28 wherein the managing party may select an option to delete a communication channel and reject communication with a non-managing party.

33. The system of claim 28 wherein the deleted communication channel is stored on the database management server to be used to determine if an email message was sent from an email address associated with the deleted communication channel.

34. The system of claim 28 further comprising an advertising management server.
